(19) United States
(12) Patent Application Publication
(10) Pub. No.: US 2015/0289554 A1
(43) Pub. Date: Oct. 15, 2015

(54) Fast Dissolving Solid Calcium Mineral Supplement Compositions and Processing Making

(71) Applicant: OTC Nutrition LLC, Manhattan, KS (US)

(72) Inventor: David K. Yang, Manhattan, KS (US)

(73) Assignee: OTC Nutrition LLC, Manhattan, KS (US)

(21) Appl. No.: 14/434,800

(22) PCT Filed: May 31, 2013
(86) PCT No.: PCT/US2013/043611

§ 371 Date: Apr. 10, 2015

Related U.S. Application Data
(60) Provisional application No. 61/718,209, filed on Oct. 25, 2012.
(60) Provisional application No. 61/757,871, filed on Jan. 29, 2013.

(51) Int. Cl. A23L 1/304; A23L 2/395; A23L 1/00

(52) U.S. Cl. CPC A23L 1/3045; A23L 1/0026; A23L 2/395; A23V 2002/00

(57) ABSTRACT

Fast dissolving edible solid nutritional supplement compositions having one or more calcium mineral sources, a citric and malic acid component, and an edible carbon dioxide-generating bicarbonate component in an amount sufficient to aid in dispersing the calcium mineral source but without inhibiting the chelate complex formation between the calcium mineral source(s) and the citric and malic acid component. Each of the calcium mineral source(s), the citric and/or malic acid component and bicarbonate component have at least about 90% particulates with a particle size of less than about 74 microns. Also, a method for preparing these compositions.

### CROSS-REFERENCE TO RELATED APPLICATIONS

This application makes reference to and claims the benefit of the following co-pending U.S. Provisional Patent Application Nos. 61/718,209, filed Oct. 25, 2012, and 61/757,871, filed Jan. 29, 2013. The entire disclosure and contents of the foregoing Provisional Applications are hereby incorporated by reference.

### FIELD OF THE INVENTION

The present invention broadly relates to fast dissolving edible solid nutritional supplement compositions comprising a calcium mineral source, an citric and malic acid component, and an edible carbon dioxide-generating bicarbonate component in an amount sufficient to aid in dispersing the calcium mineral source but without inhibiting the chelate complex formation between the calcium mineral source and the citric and malic acid component, each of the calcium mineral source, the citric and/or malic acid component and bicarbonate component having at about 90% particulates with a particle size of less than about 74 microns. The present invention also broadly relates to methods for making these compositions.

### BACKGROUND

Mineral and vitamin supplements are recognized to be important for those who have inadequate diets, including and particularly women and children in order to alleviate the problem of improper diet, supplementation of such diets with certain minerals and vitamins, such as by the use of vitamin supplement pills, fortified foods (e.g., fortified beverages), other nutritional supplements, etc., may be required.

Several minerals may be necessary for complete nutrition, and calcium is one of the most vital of these minerals. Calcium is the fifth most abundant element in the human body, and plays an important role, not only for bone building, but also in many physiological processes, including nerve and muscle functions, Calcium deficiency may interfere with muscular contraction and can also result in depletion of skeletal calcium. Osteoporosis is also a recognized nutritional problem, and numerous calcium fortified compositions are presently being marketed in an attempt to overcome this problem.

Nutritional supplementation, especially fortification of foods such as beverages, with various minerals, such as calcium, may be difficult for many reasons. These minerals generally cause unacceptable taste qualities and importantly, may interact (e.g., react) with other components in such products, including other minerals, as well as any vitamins present. In fact, as the number and amount of these minerals (as well as vitamins) in such products increases, the problem of adverse interaction between these minerals (and vitamins present) likewise grows greater. For example, the mineral cations present in oxidative environments that often exist in such products may react, degrade, etc., thus depleting the amount of the bioavailable form of the mineral source present in the product, causing unacceptable taste, as well as undesirable discoloration and sedimentation issues in the product, etc. As a result, mineral (as well as vitamin) fortification of foods, such as in beverage products, for example, fruit juices and juice beverages which may contain many reactive components, may necessitate compromises in such fortification (e.g., such minerals, as well as vitamins, may only be present in minimal or trace amounts) to lessen the potential impact of such undesirable mineral (as well as vitamin) interactions in such reactive environments to avoid other impacts (e.g., undesirable taste, discoloration and sedimentation) on consumer acceptance of such products.

For powdered beverages and dry mix delivery applications, such as a dissolvable tablet, the nutritional supplementation with calcium should rapidly dissolve without sediment or precipitating out of solution. U.S. Pat. No. 6,833,146 discloses a powdered beverage with no visible or very minimal calcium sedimentation requiring the aid of sugar with acid and calcium for dispersion and dissolution in less than about 60 sec with stirring by hand

### SUMMARY

According to a first broad aspect of the present invention, there is provided a product comprising an edible solid nutritional composition which is soluble in an aqueous liquid and which comprises:
a citric and malic acid component in an amount sufficient to provide a level of total acids of at least about 0.2% by weight when solubilized in the aqueous liquid;
a nutritionally supplemental amount of a calcium mineral source which can be solubilized by and form a chelate complex with the citric and malic acid component in the aqueous liquid; and
an edible solid carbon dioxide-generating bicarbonate component in an amount sufficient to aid in dispersing the calcium mineral source in the aqueous liquid but without significantly inhibiting the chelate complex formation between the calcium mineral source and citric and malic acid component in the aqueous liquid;
wherein the calcium mineral source, the citric and/or malic acid component and the bicarbonate component each comprise at least about 90% particulates with a particle size of less than about 74 microns.

According to a second broad aspect of the present invention, there is provided a product comprising an edible solid nutritional composition which is soluble in an aqueous liquid and which comprises:
from about 20 to about 55% by weight of the nutritional composition of a citric and malic acid component;
at least about 5% by weight of the composition of a calcium mineral source which can be solubilized by and form a chelate complex with the citric and malic acid component in the aqueous liquid; and
at least about 6% by weight (such as at least about 10% by weight) of the nutritional composition of an edible solid carbon dioxide-generating bicarbonate component in an amount sufficient to aid in dispersing the calcium mineral source in the aqueous liquid but without significantly inhibiting the chelate complex formation between the calcium mineral sources and the citric and malic acid component in the aqueous liquid;
wherein the calcium mineral source, the citric and/or malic acid component and the bicarbonate component each comprise at least about 90% particulates with a particle size of less than about 74 microns.

According to a third broad aspect of the present invention, there is provided a granulation process for preparing an edible solid nutritional composition which is soluble in an aqueous liquid and which comprises the following steps:
(a) spraying a solution of ethanol and water in a weight ratio of ethanol:water of with at least 90:10, most preferably a weight ratio of at least 95:5, onto a dry powder during continuous mixing to form small granular beads, the dry powder comprising:
   (1) a nutritionally supplemental amount of a calcium mineral source which can be solubilized by and form a chelate complex with a citric and malic acid component in the aqueous liquid;
   (2) an edible solid carbon dioxide-generating bicarbonate component in an amount sufficient to aid in dispersing the calcium mineral sources in the aqueous liquid but without significantly inhibiting the chelate complex formation between the calcium mineral source and the citric and malic acid component in the aqueous liquid; and
   (3) a soluble binding agent component, preferably such as maltodextrin, in an amount of at least 1% by weight when solubilized in the aqueous liquid sufficient to bind the above components into a granular matrix; and
   (4) wherein each of the calcium mineral source and the bicarbonate component have at least about 90% particulates with a particle size of less than about 74 microns;
(b) after the small granular beads are formed in step (a), adding a citric and malic acid component in an amount sufficient to provide a level of total acids of at least about 0.2% by weight when solubilized in the aqueous liquid mineral source into the small granular beads to provide a final granulated mixture having homogeneity, and
(c) optionally mixing the final granulated mixture with other desirable components and then drying to a moisture content of less than 2% w/w.

According to a fourth broad aspect of the present invention, there is provided a process for preparing an edible aqueous liquid nutritional composition, which comprises the following steps:
(a) providing an edible solid nutritional composition which is soluble in an aqueous liquid, which comprises:
   (1) a citric and malic acid component in an amount sufficient to provide a level of total acids of at least about 0.2% by weight when solubilized in the aqueous liquid;
   (2) a nutritionally supplemental amount of a calcium mineral sources which can be solubilized by and form a chelate complex with the citric and malic acid component in the aqueous liquid; and
   (3) an edible solid carbon dioxide-generating bicarbonate component in an amount sufficient to aid in dispersing the calcium mineral sources in the aqueous liquid but without significantly inhibiting the chelate complex formation between the calcium mineral source and the citric and malic acid component in the aqueous liquid;
   (4) wherein each of the calcium mineral source, the citric and/or malic acid component and the bicarbonate component have at least about 90% particulates with a particle size of less than about 74 microns;
(b) when solubilized in the aqueous liquid to cause the bicarbonate component to generate carbon dioxide to thereby disperse the calcium mineral source in the aqueous liquid and to thereby provide an edible aqueous liquid nutritional composition comprising a solubilized chelate complex formed between the calcium mineral source and the citric and malic acid component.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the terms “edible,” refers to any product, composition, component, ingredient, additive, material, etc., which may be orally ingested, and which is generally safe for humans, other animals, etc., to eat. Edible products and edible compositions, may include, for example, foods (e.g., beverages, pet foods, etc.), nutritional supplements, products for preparing such foods and supplements, etc.

For the purposes of the present invention, the terms “food”, “food ingredient” or “food product” refer to the common meaning of these terms and include any product classified as a “food” by the U.S. Food and Drug Administration, including weight loss products, meal replacement products, etc. Food products may include any product that may be directly drunk or ingested or that may be further mixed with other ingredients to form a product that may be drunk or ingested. For example, a food product may be mixed with an aqueous liquid to form a drink, etc. A food product may in various forms such as, for example, a nutritional supplement, a nutritional beverage, a tablet or powder (e.g., a beverage tablet or powder, etc.) used to form an ingestible food such as a liquid drink or beverage, vitamin fortified waters, fruit juices such as apple juice, orange juice, grape juice, grapefruit juice, cranberry juice, etc., vegetable juices such as tomato juice, carrot juice, etc., mixtures of fruit and/or vegetable juices, coffee, tea, milk, etc.

For the purposes of the present invention, the term “food additive” refers to the common meaning of the term “food additive” and includes any product classified as a “food additive” by the U.S. Food and Drug Administration. Food additives may include non-caloric sweeteners, colorants, bulking agents (e.g., polydextrose), fat substitutes such as olestra, etc.

For the purposes of the present invention, the term “nutritional supplement” refers to a product, composition, etc., which may provide nutritional benefits in terms of, for example, providing nutritional minerals, vitamins, etc. Nutritional supplements may include tablets, powders, energy beverages (e.g., energy drinks, etc.), etc.

For the purposes of the present invention, the term “nutritionally supplemental amount” refers to an amount of a nutritional mineral source, vitamin, etc., which provides a measurable nutritional benefit to the individual consuming the edible nutritional product, composition, etc. Nutritionally supplemental amounts of a particular nutritional mineral source, vitamin, etc., may be measured in terms of RDA values.

For the purposes of the present invention, the term “RDA” refers to the Recommended Dietary Allowances for minerals, vitamins, etc., including iron (II) mineral sources, calcium mineral sources, other trace minerals, vitamin C, vitamin D, etc. These Recommended Dietary Allowances (RDAs) are a set of estimated nutrient allowances established by the National Academy of Sciences, which are updated periodically to reflect current scientific knowledge.

For the purposes of the present invention the term “serving” refers to the appropriate serving size for a food product, for example, a nutritional beverage, weight loss product, meal substitute, etc., a nutritional supplement, etc., as established by the United States Food and Drug Administration (FDA) and the Nutrition and Labeling Act (NLEA), as set forth in 21 C F R §101, or any subsequent version of the FDA regulatory rules that may correspond to 21 C F R §101. The present invention also adopts the NLEA's definition of a serving size as being the amount of food customarily eaten at one time. When the food product of the present invention comprises a nutritional beverage or liquid meal substitute, a typical serving size may be from about 230 to about 530 mL. A single serving of the food product may be packaged in various types of, for example, “single serving” packages/containers that are well known in the art.

For the purposes of the present invention, the terms “solids basis” and “dry basis” refer interchangeably to the weight percentage of each of the respective solid compounds, components, ingredients, materials, substances, etc. (e.g., edible citric and malic acid component, calcium mineral source, edible carbon dioxide-generating bicarbonate component, other mineral sources such as iron (II) mineral sources, edible high ferric ion reducing agents such as ascorbic acid, other trace minerals, vitamins, etc) present in the absence of any liquids (e.g., water). Unless otherwise specified, all percentages given herein for solid compounds, components, ingredients, materials, substances, etc., are on a solids basis.

For the purposes of the present invention, the term “solid” refers to compositions, compounds, components, ingredients, materials, etc., which are characterized by structural rigidity and resistance to changes of shape or volume at the temperature of use (e.g., room temperature).

For the purposes of the present invention, the term “solid nutritional composition” refers to embodiments of the edible nutritional compositions that are solid at room temperature. Solid nutritional compositions may be in the form of, for example, tablets, capsules, pills, granules, powders, etc. Embodiments of the solid nutritional compositions of the present invention may have a moisture content of less than about 2%. Products comprising embodiments of the solid nutritional compositions of the present invention may be in an amount of from about 2.5 to about 5 g. (e.g., about 3 g), and sufficient to provide an ingestible or drinkable beverage when combined with about 8 oz of an aqueous liquid (e.g., water, fruit juice, etc)

For the purposes of the present invention, the term “particle size” refers to the percentage of particulates present in the solid composition, compound, component, ingredient, material, etc., which pass through a screen of the specified mesh size. For example, for particulates having a particle size of less than about 74 microns, those particles pass through a 200 mesh (U.S.)/200 mesh (Tyler) screen. For particulates having a particle size of less than about 44 microns, those particles pass through a 325 mesh (U.S.)/325 mesh (Tyler) screen.

For the purposes of the present invention, the term “liquid” refers to a non-gaseous fluid composition, compound, component, ingredient, material, etc., which may be readily flowable at the temperature of use (e.g., room temperature) with little or no tendency to disperse and with a relatively high compressibility.

For the purposes of the present invention, the term “liquid nutritional composition refers to nutritional compositions that are liquid at room temperature and prepared by combining an edible solid nutritional composition with an aqueous liquid (e.g., water). Liquid nutritional compositions may be in the form of solutions, etc., for example, aqueous foods (i.e., those comprising water as solubilizing agent, with or without other solubilizing agents, carriers, etc., such, as for example, alcohol, etc.). Examples of liquid foods may include: beverages or drinks (e.g., soda), fruit juices, vegetable juices, coffee, tea, milk, etc. Examples of liquid nutritional supplements may include: liquid concentrates, extracts, energy beverages (e.g., energy drinks, etc.), etc.

For the purposes of the present invention, the term “calcium mineral source” refers to any source of calcium which may form a calcium citrate malate chelate complex with a citric and malic acid component in an aqueous liquid. Besides forming a calcium citrate malate chelate complex, such calcium mineral sources additionally provide a nutritional benefit. These calcium mineral sources may include one or more of: calcium hydroxide (also referred to as “calcium hydrate” or “hydrated lime”), calcium carbonate, calcium citrate, calcium malate, calcium oxide, calcium chloride, calcium phosphates/calcium hydrogen phosphates (e.g., monobasic calcium phosphate, dibasic calcium phosphate, tricalcium phosphate, etc), calcium sulfate, calcium lactate, calcium benzoate, calcium ascorbate, calcium sorbate, calcium lactate gluconate, calcium propionate, calcium acetate, calcium caseinate, calcium cyclamate, calcium panthothenate, calcium stearate, calcium stearyl lactylate, calcium tartrate, etc.

For the purposes of the present invention, the term “calcium citrate malate chelate complex” refers to an at least meta-stable chelate complex of calcium with citrate and malate anions. Besides increasing calcium solubilization, another benefit of calcium citrate malate is that this complex does not interfere, or at least does not interfere in a significant way with the bioavailability or absorption of other minerals, including trace minerals, for example, iron.

For the purposes of the present invention, the term “citric and malic acid component” refers an acid component which comprises a mixture of citric acid and malic acid (e.g., in an amount of from about 95 to 100% by weight, such as from about 98 to 100% by weight). In addition to citric acid and malic acid, the citric and malic acid component may optionally comprise one or more edible carboxylic acids such as fumaric acid, maleic acid, tartaric acid, succinic acid, malonic acid, glutaric acid, adipic acid, aspartic acid, glutaconic acid, glutamic acid, phosphoric acid, etc., as well as any edible salts such of edible carboxylic acids (e.g., sodium salt, potassium salt, calcium salt, magnesium salt, etc)

For the purposes of the present invention, the term “total acids” refers to the combined amount of citric acid and malic acids (plus any other optional edible carboxylic acids) which are present in the aqueous liquid. The amount of the citric and malic acid component is sufficient to provide a level of total acids of at least about 0.2% by weight when solubilized in the aqueous liquid, for example, from about 0.2 to about 0.7% by weight, such as from about 0.3 to about 0.5% by weight

For the purposes of the present invention, the term “carbon dioxide-generating bicarbonate component” refers to a composition, compound, material, ingredient, etc., which comprise bicarbonates and are capable of generating carbon dioxide (gas) in an aqueous liquid in the presence of the citric and malic acid component. Suitable edible solid carbon dioxide-generating bicarbonate components for use herein may include one or more of: edible monovalent cation bicarbonates such as sodium bicarbonate, potassium bicarbonate, ammonium bicarbonate, etc.

For the purposes of the present invention, the term “an amount sufficient to aid in dispersing the calcium mineral source in the aqueous liquid” refers to an amount of the edible solid carbon dioxide-generating bicarbonate component which is effective to generate sufficient carbon dioxide (gas) in an aqueous liquid in the presence of the citric and malic acid component to create sufficient agitation, bubbling, mixing, stirring, etc., in the aqueous liquid and thus cause measurable dissolution, dispersion, etc., of the calcium mineral source in the aqueous liquid, but without significantly inhibiting the chelate complex formation between the calcium mineral source and the citric and malic acid component in the aqueous liquid. Suitable amounts of the edible solid carbon dioxide-generating bicarbonate component may be, for example, in a weight ratio of the edible solid carbon dioxide-generating bicarbonate component to the citric and malic acid component of from about 1:1 to about 1:45, such as from about 1:1.1 to about 1:3.

For the purposes of the present invention, the term “iron (11) mineral source” refers to any source of iron which may provide nutritional benefit, and which may exist in the divalent state (e.g., are “ferrous” compounds/salts) Suitable iron (II) mineral sources may include one or more of: ferrous bis-glycinate (Ferrochel), ferrous glycine sulfate (ferroglycine sulfate), ferrous fumarate, ferrous gluconate, ferrous succinate, ferrous lactate, ferrous tartrate, ferrous citrate, ferrous sulfate, ferrous ammonium sulfate, ferrous iodide, etc. See U.S. Provisional Pat. Appln. Ser. No. 61/588,680, filed Jan. 20, 2012, the entire disclosure and contents of which is herein incorporated by reference.

For the purposes of the present invention, the term “high ferric ion reducing agent” refers to an agent which measurably retards the tendency of ferrous cationic species to be oxidized (converted) to ferric cationic species (i.e., tends to reduce the ferric species and thus creates a high reducing potential environment for the ferrous species). Edible high ferric ion reducing agents may include one or more of ascorbic acid, edible ascorbic acid salts (e.g., sodium ascorbate, potassium asorbate, etc), edible ascorbic acid esters (e.g., ascorbyl palmitate, ascorbyl stearate, etc), erythorbic acid (the stereoisomer of ascorbic acid), or edible erythorbic acid salts (e.g., sodium erythorbate, potassium erythorbate, etc), edible erythorbic acid esters (e.g., erythorbyl palmitate, erythorbyl stearate, etc), etc.; sulfites, such as sodium sulfite, potassium sulfite, etc.; etc. Besides functioning as a high ferric ion reducing agent, any ascorbic acid and/or edible ascorbic acid salts present may additionally provide nutritional benefit as a source of vitamin C, may impart other antioxidant benefits, etc. See U.S. Provisional Pat. Appln. Ser. No. 61/588,680, filed Jan. 20, 2012, now claimed for priority benefit by PCT Appln. Serial No. PCT/US13/021526, filed Jan. 15, 2013, the entire disclosure and contents of both applications being herein incorporated by reference.

For the purposes of the present invention, the term “binding agent” means various compounds, components, ingredients, substances, materials, layers, steps, etc., which provides tendency to bind together other components in the presence of moisture. Suitable edible, water soluble binding agent components may be conjointly employed herein and may include one or more of: maltodextrin, polydextrose, hydroxylmethylcellulose, modified food starches, acacia gum, flavors, etc.

For the purposes of the present invention, the term “bioavailable” refers to a mineral source (e.g., a calcium mineral source, an iron (II) mineral source, etc.) which is available for absorption by the gut.

For the purposes of the present invention, the term “vitamin C” refers to compounds, compositions, etc., which may include ascorbic acid (L-ascorbic acid), edible salts of ascorbic acid (L-ascorbate salts), etc., edible esters of ascorbic acid (ascorbyl palmitate), etc., as well as mixtures thereof

For the purposes of the present invention, the term “vitamin D” refers to compounds, compositions, etc., which may include vitamin D₃, vitamin D₂, 25(OH)D₃, 25(OH)D₂, 1α,25(OH)₂ D₃, 1α,25(OH)₂ D₂, etc, as well as mixtures thereof.

For the purposes of the present invention, the term “trace minerals” refers to those minerals which are important for bone growth and age-related bone health. These trace minerals may include zinc, magnesium, manganese, copper, potassium, etc., as well as mixtures thereof.

For the purposes of the present invention, the term “fruit juice” refers to citrus juices, noncitrus juices such as apple juice, grape juice (e.g., from concord grapes, etc.), pear juice, cherry juice, berry juice (e.g., from blueberries, cranberry, bilberry, black raspberry, red raspberry, blackberry, chokeberry, etc.), black currant juice, acai juice, pineapple juice, peach juice, apricot juice, plum juice, prune juice, etc., as well as mixtures of these juices.

For the purposes of the present invention, the term “room temperature” refers to the commonly accepted meaning of room temperature, i.e., an ambient temperature of 20° to 25° C.

For the purposes of the present invention, the terms “container” and “package” are used interchangeably and refer to a package or container that contains the embodiments of the edible solid nutritional composition of the present invention. The specific type of package or container, either of a single-serving size or any other size, used as a container for the embodiments of the edible solid nutritional composition of the present invention may depend on such factors as whether the composition is a tablet, powder, etc., whether the composition includes perishable components, whether the composition is sensitive to moisture, oxygen, etc.

For the purposes of the present invention, the term “comprising” means various compounds, components, ingredients, substances, materials, layers, steps, etc., may be conjointly employed. Accordingly, the term “comprising” encompasses the more restrictive terms “consisting essentially of” and “consisting of.”

### Description

Calcium fortification of foods and beverages may be difficult because of the poor solubility of certain calcium salts in solution. While dietary calcium supplements may provide important sources of calcium, such sources may need to be ingested with other foods or over time in multiple does, and may also have poor bioavailability due to slow dissolution in the stomach and poor solubility. When used in aqueous solutions, such as beverages, poor solubility of the calcium salts may not only cause precipitation in fortified products but also may also cause a chalky taste and undesirable aftertaste problems.

The present invention broadly relates to relatively fast dissolving edible solid nutritional compositions which may create minimal or no precipitation when solubilized in aqueous liquids (e.g., water) which comprise a nutritionally supplemental amount of one or more calcium mineral sources and which may optionally include other micronutrient sources, vitamin D, ascorbic acid, iron, and magnesium. Besides the calcium mineral source, the edible solid nutritional composition comprises a citric and malic acid component in an amount sufficient to provide a level of total acids of at least about 0.2% by weight when solubilized in the aqueous liquid. This edible solid nutritional composition also comprises an edible solid carbon dioxide-generating bicarbonate component having at least about 90% particulates (such as at least about 95% particulates) with a particle size of less than about 74 microns and in an amount sufficient to aid in dispersing the calcium mineral source in the aqueous liquid, but without significantly inhibiting the chelate complex formation between the calcium mineral source and the citric and malic acid component in the aqueous liquid. These edible solid nutritional compositions provide fast dissolution of the calcium through an acid solubilized chelate complex but without the need of hand or mechanical stirring.

Embodiments of the edible solid nutritional compositions of the present invention (e.g., tablets, powders, granules, etc) permit the formation of more bioavailable calcium mineral sources in-situ when added to an aqueous solution or beverage due the creation of a chelate complex between the calcium mineral source, such as a calcium hydroxide (hydrate), and the citric and malic acid component, such as a citric acid and malic acid component. For example, the chelated complex calcium citrate malate (CCM), a highly soluble calcium source, disclosed in, for example, U.S. Pat. No. 4,722,847 (Heckert), issued Feb. 2, 1988, and U.S. Pat. No. 4,737,375 (Nakel et al.), issued Apr. 12, 1988 (the entire disclosures and contents of which are herein incorporated by reference) may be formed by using embodiments of the edible solid nutritional compositions of the present invention.

Rapid chelate complex formation is aided by the presence of the edible solid carbon dioxide-generating bicarbonate component, such as sodium bicarbonate or potassium bicarbonate, which generates bubbling, agitation, mixing, stirring, etc., in the aqueous liquid to which the edible solid nutritional composition is added. In addition, each of the calcium mineral source, the citric and/or malic acid component and the edible solid carbon dioxide-generating bicarbonate component have a specified particle size, i.e., at least about 90% particulates with a particle size of less than about 74 microns. In some embodiments, the calcium mineral source and the edible solid carbon dioxide-generating bicarbonate component may comprise at least about 95% particulates with a particle size of less than about 74 microns. In other embodiments, the calcium mineral source and the edible solid carbon dioxide-generating bicarbonate component may comprise at least about 75% particulates (such as at least about 80%) with a particle size of less than about 44 microns. Reducing the particle size of the particulates present in the calcium mineral source, as well as the citric and/or malic acid component and edible solid carbon dioxide-generating bicarbonate component, to less than about 74 microns avoids or minimizes interference with the calcium chelate complex formations, as well as resulting in little to no precipitation when the edible solid nutritional composition is added to an aqueous liquid media. In particular, the use of such particle size distribution in the embodiments of the edible solid nutritional composition avoids or minimizes slow dissolution of the calcium mineral source and the edible solid carbon dioxide-generating bicarbonate component (e.g., sodium bicarbonate) particles that may result in insoluble calcium precipitates and chalky taste residues.

In embodiments of the edible solid nutritional composition of the present invention, the edible solid carbon dioxide-generating bicarbonate component is present in amounts sufficient to aid in dispersing the calcium mineral source in the aqueous liquid but without significantly inhibiting the chelate complex formation between the calcium mineral source and the citric and malic acid component in the aqueous liquid. In some embodiments, the edible solid carbon dioxide-generating bicarbonate component (e.g., sodium bicarbonate) may be present, for example, in an amount of at least about 6% by weight (for example, at least about 10% by weight) of the nutritional composition, such as at least about 13% by weight of the nutritional composition, e.g., from about 13% to about 20% by weight of the nutritional composition, or at least about 15% by weight of the nutritional composition, e.g., from about 17% to about 25% by weight of the nutritional composition.

The calcium mineral source is present in a nutritionally supplemental amount in embodiments of the edible solid nutritional composition of the present invention, and may be a highly bioavailable form resulting from a solubilized calcium complex with the citric and malic acid component (e.g., a solubilized calcium citrate malate chelate complex). The calcium mineral source, for example, calcium hydroxide (hydrate), may be present in an amount of at least about 5% by weight (e.g., at least about 6% by weight) of the edible solid nutritional composition, such as up to about 28% by weight of the nutritional composition, e.g., from about 5% to about 28% by weight (such as from about 6% to about 28% by weight) of the nutritional composition. The amount of the solubilized calcium in the resulting ingestible (e.g., drinkable) beverage (i.e., after adding to edible solid nutritional composition to an aqueous liquid) may be, for example, in an amount sufficient to provide at least about 0.04% solubilized calcium by weight of the resulting liquid nutritional composition (e.g., ingestible beverage), such as at least about 0.12% by weight of the resulting ingestible beverage, e.g., a one serving size beverage. For example, the amount of calcium may be in an amount sufficient to provide from about 0.04% to about 0.21% solubilized calcium by weight of the resulting ingestible beverage. The amount of the calcium mineral source present in the final ingested product may provide at least about 10% of the RDA of calcium per serving, such as at least about 30% of the RDA of calcium per serving.

In embodiments of the edible solid nutritional composition of the present invention, the citric and malic acid component is present in amounts which provide a level of total acids of greater than about 0.2% by weight (for example, from about 0,2 to about 0,7% by weight, such as from about 0.3 to about 0.5% by weight) when solubilized in the aqueous liquid. For example, in some embodiments the citric and malic acid component may be present in an amount of at least about of at least about 20% by weight of the nutritional composition, such as from about 20% to about 55% by weight of the nutritional composition, e.g., from about 35% to about 40% by weight of the nutritional composition. In some embodiments of the citric and malic acid component, the amount, respectively, of citric acid may be in the range of from about 11% to about 32% by weight of the nutritional composition, while the amount of malic acid may be, for example, in the range of from about 9% to about 23% by weight of the nutritional composition. In some embodiments of the citric malic acid component, the citric acid and malic acid may be in a weight ratio of from about 4:1 to about 1:2, such as from about 3:1 to about 1:1, e.g., a weight ratio of citric acid to malic acid of about 5:2. While the citric and malic acid component is included in the edible solid nutritional composition of the present invention to solubilize the calcium mineral source, the citric and malic acid present in this component additionally react with the edible solid carbon dioxide-generating bicarbonate component (e.g., sodium bicarbonate) to generate carbon dioxide gas and thus provide bubbling, agitation, mixing, stirring, etc, to increase solubilization of other components present in the edible solid nutritional composition in the aqueous liquid The effectiveness of this solubilization in increased when either the citric acid or malic acid or combinations thereof has a specified particle size, i.e., at least about 90% particulates with a particle size of less than about 74 microns.

Embodiments of the edible solid nutritional composition of the present invention may optionally include other highly soluble mineral sources. In some embodiments, iron (II) mineral sources, such as ferrous bis-glycinate (an amino-acid chelated iron (II) source), may be included to provide iron mineral nutritional supplementation. For example, the iron (II) mineral source may be present in the composition in an amount of from about 0.06% to about 0.20% (iron metal basis), such as from about 0.06% to about 0.15%. The iron (II) mineral source may be present in the composition in an amount sufficient to provide in the final product at least about 10% of the RDA of iron, such as from about 10 to about 30% of the RDA of iron, e.g., from about 10 to about 25% of the RDA of iron. See U.S. Provisional Pat. Appln. Ser. No. 61/588,680, filed Jan. 20, 2012, the entire disclosure and contents of which is herein incorporated by reference.

Embodiments of the edible solid nutritional composition of the present invention may optionally include high ferric ion reducing agents, such as, for example, ascorbic acid, edible ascorbic acid salts, edible ascorbic acid esters, erythorbic acid, edible erythorbic acid salts, or edible erythorbic acid esters. These high ferric ion reducing agents may be present in these nutritional compositions in an amount sufficient to measurably retard conversion of the iron (II) mineral sources from ferrous to ferric species. The ascorbic acid, edible ascorbic acid salts and/or edible ascorbic acid esters may be present, for example, in an amount of at least about 0.035% by weight of the nutritional composition, such as at least about 0.08% by weight of the composition or product. See U.S. Provisional Pat. Appln. Ser. No. 61/588,680, filed Jan. 20, 2012, the entire disclosure and contents of which is herein incorporated by reference. In some embodiments, ascorbic acid, when included to provide vitamin C fortification, may be present in an amount of, for example, at least about 1% by weight of the nutritional composition, such as at least about 3% by weight of the nutritional composition. When used for vitamin C fortification, ascorbic acid may be present in the nutritional composition in an amount sufficient to provide at least about 50% of the RDA of vitamin C, such as from about 100% to about 150% of the RDA of vitamin C.

Embodiments of the edible solid nutritional composition of the present invention may optionally contain other minerals, vitamins, etc. For example, embodiments of edible solid nutritional compositions of the present invention may optionally contain at least about 10% of the Recommended Daily Intake (RDI) for the vitamins A, B₁, B₂, B₆, B₁₂, etc., carotenoids (e.g., β-carotene, zeaxanthin, lutein, lycopene), D, E, K, β-carotene, biotin, folic acid, pantothenic acid, niacin, choline, etc.; one or more trace minerals, other minerals, including sodium, phosphorous, chloride, iodine chromium, molybdenum, selenium, etc.; the conditionally essential nutrients m-inositol, carnitine, taurine, etc., in a single serving of from about 50 Kcal to about 1000 Kcal. Those skilled in the art will also appreciate that minimum requirements may have been established for these other minerals and vitamins that are known to be necessary for normal physiological function. For example, those skilled in the art will understand that certain micronutrients may have potential benefit for people with diabetes such as chromium, carnitine, taurine, vitamin E, etc., and that higher dietary requirements may exist for certain micro nutrients such as, for example, ascorbic acid due to higher turnover in people with diabetes, etc.

Artificial sweeteners may also be included in the edible solid nutritional compositions to enhance the organoleptic quality of the formula. Examples of suitable artificial sweeteners may include saccharine, aspartame, acesulfame K (Ace K), sucralose (e.g., Tate & Lyle's Splenda®), etc. Embodiments of the edible solid nutritional compositions of the present invention may also include a flavoring and/or color to provide the compositions with an appealing appearance and an acceptable taste for oral consumption. Examples of useful flavorings typically include, for example, strawberry, peach, butter pecan, chocolate, banana, raspberry, orange, blueberry and vanilla.

Embodiments of the edible solid nutritional compositions of the present invention may also comprise a flavorant, concentrations of which may vary substantially depending upon the selected flavorant and other ingredients, as well as the desired flavor profile or intensity desired. Any flavorant that is known or otherwise suitable for use in food products may be used herein, provided that such flavorant is also compatible with the other selected materials, ingredients, additives, etc.

Such flavorants may be natural or synthetic and may be provided as a single or multiple flavored materials. Flavorants for use in these edible solid nutritional compositions are most typically a combination of many ingredients to provide the desired flavor association. Non-limiting examples of suitable flavorants include enzyme-modified flavors (e.g., dairy flavors), fermentation flavors (e.g., dairy flavors), reaction flavors (e.g., chocolate, caramel), natural extracts (e.g., vanilla, coffee, chocolate), and combinations thereof Non-limiting examples of other specific flavorants suitable for use herein may include butter pecan flavor, orange, lemon, lime, apricot, grapefruit, yuzu, sudachi, apple, grape, strawberry, pineapple, banana peach, melon, apricot, ume, cherry, raspberry, blueberry, butter, vanilla, tea, coffee, cocoa or chocolate, mint, peppermint, spearmint, Japanese mint, asafetida, ajowan, anise, angelica, fennel, allspice, cinnamon, camomile, mustard, cardamon, caraway, cumin, clove, pepper, coriander, sassafras, savory, Zanthoxyli Fructus, perilla, juniper berry, ginger, star anise, horseradish, thyme, tarragon, dill, capsicum, nutmeg, basil, marjoram, rosemary, bayleaf, wasabi, beef pork, chicken, fish, crustacean, dried and smoked fish, seaweed, wine, whisky, brandy, rum, gin, liqueur, floral flavors, onion, garlic, cabbage, carrot, celery, mushroom, tomato, and combinations thereof.

Embodiments of the edible solid nutritional compositions of the present invention may further comprise other optional components, materials, ingredients, additives, etc., that may modify the physical, chemical, aesthetic or processing characteristics of the compositions. Many such optional components, materials, ingredients, additives, etc., that are known or otherwise suitable for use in other edible nutritional compositions may also be used in the edible nutritional compositions herein, provided that such optional components, materials, ingredients, additives, etc., are safe for human consumption and are compatible with the essential and other components, materials, ingredients, additives, etc., present in these edible nutritional products or compositions. Non-limiting examples of other optional ingredients include preservatives, antioxidants, pharmaceutical actives or drugs, colorants, additional flavors, etc.

Embodiments of the edible solid nutritional compositions of the present invention may also be substantially free of any optional components, materials, ingredients, additives, etc., described herein. In this context, the term “substantially free” means that the selected product contains less than a functional amount of the optional components, materials, ingredients, additives, etc., including zero percent by weight of such optional components, materials, ingredients, additives, etc.

Embodiments of the present invention also include a process for preparing the edible solid nutritional compositions using a granulation process that comprises the following steps: (1) a calcium mineral source, an edible solid carbon dioxide-generating bicarbonate component and a soluble binding agent, such as preferably maltodextrin, are combined to form a dry powder mixture; (2) forming (e.g., mixing) a solution of ethanol and water in a weight ratio of ethanol water of at least 90:10, most preferably 95:5, which is sprayed onto the dry powder mixture until small granular beads are formed and mixed to homogeneity; (3) the citric and malic acid components are added to the small granular beads and mixed to homogeneity; and (4) the formed granules (i.e., the small granular beads) from step (3) are dried (or optionally mixed with other desirable formulation components before drying) to a final moisture content of less than 2% w/w.

Embodiments of the edible solid nutritional compositions of the present invention in the form of tablets, powders, etc., may be prepared by simply mixing together the prepared granules (i.e., the small granular beads) with other dry ingredients using conventional techniques for preparing tablets, powders, etc., known to those skilled in the art. Moisture may be minimized in the preparing embodiments of the edible solid nutritional compositions of the present invention so that the moisture content of the resulting nutritional composition is less than about 2%.

Embodiments of the present invention may include processes for preparing an edible, ready-to-drink aqueous liquid nutritional composition (e.g., ingestible or drinkable beverage) from these edible solid nutritional compositions. In these processes, the edible solid nutritional compositions is combined with (e.g., added to, stirred in, etc) an aqueous liquid (e.g., water, fruit juice, etc.) to cause the edible solid carbon dioxide-generating bicarbonate component to generate carbon dioxide to thereby disperse the calcium mineral source in the aqueous liquid and to thereby provide the edible aqueous liquid nutritional composition (e.g., a drinkable beverage) comprising a solubilized chelate complex formed between the calcium mineral source and the citric and malic acid component.

### EXAMPLES

Illustrative examples of embodiments of edible nutritional products or compositions are shown below:

### Example 1

A fast dissolving nutritional supplement tablet (3 g) to be used in one cup (8 oz) water is formulated from the following ingredients (Table 1):

TABLE 1

| Ingredient | % w/w |
|---|---|
| Citric Acid | 27.84 |
| Malic Acid | 18.66 |
| Calcium Hydroxide* | 15.64 |
| Sodium Bicarbonate* | 16.76 |
| Ferrous bis-glycinate (20% Iron) | 0.75 |
| Ascorbic Acid | 2.26 |
| Vitamin D 100 | 0.03 |
| Flavor | 11.84 |
| Ace K | 0.63 |
| Sucralose | 0.38 |
| Magnesium Sulfate | 2.86 |
| Polyethylene Glycol | 2.14 |
| Anthro Red Color | 0.21 |

*at least 95% of the particles are less than 74 microns, i.e., pass through a 200 mesh screen

For a 1 kg batch, citric acid (278 g), malic acid (187 g), sodium bicarbonate (168 g) calcium hydroxide (156 g) are well mixed into a homogeneous mix. The remaining ingredients are then added and mixed together to provide a homogenous mixture. For a tableting powder, this mixture has a moisture content of less than 2% The powder is then allotted and pressed into 3 g tablets with typical dimension of 20 mm diameter and 0.269 mm thickness. The final tabletted product, when added at one tablet per one cup water (8 oz), for example, is generally dissolved in less than about 5 minutes, such as less than 3 minutes with little or no precipitation.

### Example 2

A fast dissolving energy hydration tablet (3 g) to be used in one cup (8 oz) water is formulated from the following ingredients (Table 2):

TABLE 2

| Ingredient | % w/w |
|---|---|
| Citric Acid | 27.18 |
| Malic Acid | 10.83 |
| Calcium Hydroxide* | 6.37 |
| Sodium Bicarbonate* | 18.29 |
| Ferrous bis-glycinate (20% Iron) | 0.61 |
| Ascorbic Acid | 2.26 |
| Green Tea Extract | 5.95 |
| Flavor | 14.20 |
| Ace K | 0.72 |
| Sucralose | 0.43 |
| Magnesium Sulfate | 2.92 |
| Polyethylene Glycol | 2.53 |
| Anthro Red Color | 0.91 |
| Maltodextrin | 6.80 |

*at least 95% of the particles are less than 74 microns, i.e., pass through a 200 mesh screen

For a 1 kg batch, citric acid (272 g), malic acid (108 g), sodium bicarbonate (183 g) calcium hydroxide (64 g) are well mixed into a homogeneous mix The remaining ingredients are then added and mixed together to a homogenous mixture. For a tableting powder, this mixture has a moisture content of less than 2% The powder is then allotted and pressed into 3 g tablets with typical dimension of 20 mm diameter and 0.269 mm thickness. The final tablet product, adding one tablet per one cup water (8 oz), for example, is generally dissolved in less than about 5 minutes, such as less than 3 minutes with little or no precipitation.

### Example 3

A fast dissolving nutritional supplement tablet (3 g) to be used with one cup (8 oz) water is formulated from the following ingredients (Table 3):

TABLE 3

| Ingredient | % w/w |
|---|---|
| Citric Acid* | 27.84 |
| Malic Acid | 18.66 |
| Calcium Hydroxide* | 15.64 |
| Sodium Bicarbonate* | 16.76 |
| Ferrous bis-glycinate (20% Iron) | 0.75 |
| Ascorbic Acid | 2.26 |
| Vitamin D 100 | 0.03 |
| Flavor | 9.84 |
| Maltodextrin | 2.00 |
| Ace K | 0.63 |
| Sucralose | 0.38 |
| Magnesium Sulfate | 2.86 |
| Polyethylene Glycol | 2.14 |
| Anthro Red Color | 0.21 |

*at least 95% of the particles are less than 74 microns, i.e., pass through a 200 mesh screen

For a 1 kg batch, calcium hydroxide (156 g), sodium bicarbonate (168 g), maltodextrin (20 g) and flavor (98.4 g) are well mixed into a homogeneous mixture. A solution of ethanol and water of a 95:5 w/w % ratio is prepared and sprayed onto the dry powder mixture with continuous mixing until small granular beads are formed (approximately 80-90 g of spray is added). With continuous mixing, citric acid (278 g) and malic acid (187 g) are added. The remaining ingredients are then added and mixed together to provide a homogenous mixture. This final mixture is dried at 120° F. for 2-4 hours typically or until the final moisture content is of less than 2%. The dry mix is then allotted and pressed into 3 g tablets with typical dimension of 20 mm diameter and 0.269 mm thickness. The final tablet product, when added at one tablet per one cup water (8 oz), for example, is generally dissolved in less than about 5 minutes, such as less than 3 minutes with tittle or no precipitation.

### Example 4

A fast dissolving energy hydration tablet (3 g) to be used in one cup (8 oz) water is formulated from the following ingredients (Table 4):

TABLE 4

| Ingredient | % w/w |
|---|---|
| Citric Acid | 27.18 |
| Malic Acid | 10.83 |
| Calcium Hydroxide* | 6.37 |
| Sodium Bicarbonate* | 18.29 |
| Ferrous bis-glycinate (20% Iron) | 0.61 |
| Ascorbic Acid | 2.26 |
| Green Tea Extract | 5.95 |
| Flavor | 12.20 |
| Maltodextrin | 2.00 |
| Ace K | 0.72 |
| Sucralose | 0.43 |
| Magnesium Sulfate | 2.92 |
| Polyethylene Glycol | 2.53 |
| Anthro Red Color | 0.91 |
| Maltodextrin | 6.80 |

*at least 95% of the particles are less than 74 microns, i.e., pass through a 200 mesh screen

For a 1 kg batch, calcium hydroxide (64 g), sodium bicarbonate (183 g), maltodextrin (20 g) and flavor (122 g) are well mixed into a homogeneous mix. A solution of ethanol and water at a 95:5 w/w % ratio ethanol:water is prepared and sprayed onto the dry powder mixture with continuous mixing until small granular beads are formed (approximately 80-90 g of spray is added). With continuous mixing, citric acid (272 g) and malic acid (108 g) are added. The remaining ingredients are then added and mixed together to provide a homogenous mixture. This final mixture is dried at 120° F. for 2-4 hours typically or until the final moisture content is of less than 2% The dry mix is then allotted and pressed into 3 g tablets with typical dimension of 20 mm diameter and 0.269 mm thickness The final tablet product, adding one tablet per one cup water (8 oz), for example, is generally dissolved in less than about 5 minutes, such as less than 3 minutes with little or no precipitation

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

1. A product comprising an edible solid nutritional composition which is soluble in an aqueous liquid and which comprises:
a citric and malic acid component in an amount sufficient to provide a level of total acids of at least about 0.2% by weight when solubilized in the aqueous liquid;
a nutritionally supplemental amount of a calcium mineral source which can be solubilized by and form a chelate complex with the citric and malic acid component in the aqueous liquid; and
an edible solid carbon dioxide-generating bicarbonate component in an amount sufficient to aid in dispersing the calcium mineral source in the aqueous liquid but without significantly inhibiting the chelate complex formation between the calcium mineral source and the citric and malic acid component in the aqueous liquid;
wherein the calcium mineral source, the citric and/or malic acid component and the bicarbonate component each comprise at least about 90% particulates with a particle size of less than about 74 microns.

2. The product of claim 1, wherein nutritional composition is the form of a tablet.

3. The product of claim 1, wherein the nutritional composition is the form of a beverage powder.

4. The product of claim 1, wherein the calcium mineral source is one or more of: calcium hydroxide or calcium carbonate.

5-6. (canceled)

7. The product of claim 1, wherein the calcium mineral source is present in an amount of from about 6 to about 28% by weight of the nutritional composition.

8. The product of claim 1, wherein the calcium mineral source and the citric and malic acid component are present in the nutritional composition in an amount sufficient to provide, when combined with the aqueous liquid, from about 0.04 to about 0.21% solubilized calcium and wherein the citric and malic acid component is from about 0.2 to about 0.7% by weight total acids in the aqueous liquid.

9. The product of claim 1, wherein the calcium mineral source, the citric and/or malic acid component and the bicarbonate component each comprise at least about 95% particulates with a particle size of less than about 74 microns.

10. The product of claim 9, wherein the calcium mineral source and the bicarbonate component each comprise at least about 75% particulates with a particle size of less than about 44 microns.

11. The product of claim 1, wherein the calcium mineral source and the bicarbonate component are combined with a binding agent and substantially uniformly dispersed within the nutritional composition.

12. The product of claim 11, wherein the binding agent is maltodextrin in an amount of at least 1% by weight when solubilized in the aqueous liquid.

13. (canceled)

14. The product of claim 1, wherein the calcium mineral source and the bicarbonate component are substantially uniformly dispersed within the nutritional composition.

15. The product of claim 1, wherein the bicarbonate component is one or more of:
sodium bicarbonate, potassium bicarbonate, or ammonium bicarbonate.

16-17. (canceled)

18. The product of claim 15, wherein the bicarbonate component comprises from about 13% to about 20% by weight of the nutritional composition.

19. (canceled)

20. The product of claim 1, wherein the citric and malic acid component comprises citric acid and malic acid in a weight ratio of from about 3:1 to about 1:1.

21. (canceled)

22. The product of claim 20, wherein the citric and malic acid component comprises from about 20 to about 55% by weight of the nutritional composition.

23. (canceled)

24. The product of claim 23 wherein the citric and/or malic acid component has at least about 90% particulates with a particle size of less than about 74 microns.

25. (canceled)

26. The product of claim 1, wherein the weight ratio of the bicarbonate component to the citric and malic acid component is from about 1:1.1 to about 1:3.

27. The product of claim 1, wherein the nutritional composition further comprises a nutritionally supplemental amount of an iron (II) mineral source.

28. The product of claim 27, wherein the iron (II) mineral source comprises ferrous bis-glycinate in an amount of from about 0.06% to about 0.20% (iron metal basis) by weight of the nutritional composition.

29. A product comprising an edible solid nutritional composition which is soluble in an aqueous liquid and which comprises:
from about 20 to about 55% by weight of the nutritional composition of a citric and malic acid component;
at least about 6% by weight of the nutritional composition of a calcium mineral sources which can be solubilized by and form a chelate complex with the citric and malic acid component in the aqueous liquid; and
at least about 13% by weight of the nutritional composition of an edible solid carbon dioxide-generating bicarbonate component in an amount sufficient to aid in dispersing the calcium mineral source in the aqueous liquid but without significantly inhibiting the chelate complex formation between the calcium mineral source and the citric and malic acid component in the aqueous liquid;
wherein the calcium mineral source, the citric and/or malic acid component and the bicarbonate component each comprise at least about 90% particulates with a particle size of less than about 74 microns.

30. The product of claim 29, wherein the calcium mineral source is calcium hydroxide.

31. The product of claim 29, wherein the bicarbonate component is sodium bicarbonate.

32. The product of claim 29, wherein each of the calcium mineral source and the bicarbonate component comprises at least about 80% particulates with a particle size of less than about 44 microns.

33. The product of claim 29, wherein the bicarbonate component and the citric and malic acid component are in a weight ratio of the bicarbonate component to the citric and malic acid component of from about 1:1.1 to about 1:3.

34. The product of claim 29, wherein the calcium mineral source and the bicarbonate component are combined with a binding agent and substantially uniformly dispersed within the nutritional composition.

35. The product of claim 34, wherein the binding agent is maltodextrin in an amount of at least 1% by weight when solubilized in the aqueous liquid.

36. A granulation process for preparing an edible solid nutritional composition which is soluble in an aqueous liquid and which comprises the following steps:
(a) spraying a solution of ethanol and water in a weight ratio of ethanol:water of at least 90:10 onto a dry powder during continuous mixing to form small granular beads, the dry powder comprising:
(1) a nutritionally supplemental amount of a calcium mineral sources which can be solubilized by and form a chelate complex with the citric and malic acid component in the aqueous liquid;
(2) an edible solid carbon dioxide-generating bicarbonate component in an amount sufficient to aid in dispersing the calcium mineral sources in the aqueous liquid but without significantly inhibiting the chelate complex formation between the calcium mineral source and the citric and malic acid component in the aqueous liquid;
(3) a soluble binding agent component in an amount of at least 1% by weight when solubilized in the aqueous liquid sufficient to bind the above components into a granular matrix; and
(4) wherein each of the calcium mineral source and the bicarbonate component have at least about 90% particulates with a particle size of less than about 74 microns;
(b) after the small granular beads are formed in step (a), adding a citric and malic acid component in an amount sufficient to provide a level of total acids of at least about 0.2% by weight when solubilized in the aqueous liquid mineral source into the granules to provide a final granulated mixture having homogeneity; and
(c) optionally mixing the final granulated mixture with other components and then drying to a moisture content of less than 2% w/w.

37. The process of claim 36 wherein the soluble binding agent component is maltodextrin in an amount of at least 1% by weight when solubilized in the aqueous liquid.

38. The process of claim 36, wherein the aqueous liquid is water.

39. The process of claim 36, wherein the weight ratio of ethanol:water is at least 95:5.
